(19) United States
(12) Patent Application Publication
(10) Pub. No.: US 2002/0115401 A1
(43) Pub. Date: Aug. 22, 2002

(54) Method and system for conveying and collating crimped sausages

(76) Inventors: Mart Kobussen, Indianola, IA (US); Jos Kobussen, Indianola, IA (US); David Alexander, Boone, IA (US); Hector Flores, Johnston, IA (US)

Correspondence Address: Zarley Law Firm PLC, Capital Square, 400 Locust Street - Suite 200, Des Moines, IA, 50309-2350, US

(21) Appl. No.: 09/790,109

(22) Filed: Feb. 21, 2001

(51) Int. Cl. A22C 11/00

(52) U.S. Cl. 452/51

(57) ABSTRACT

A system for conveying and collating a crimped line of sausage has an elongated vibratory conveyor deck powered to oscillate on a supporting frame. A tray having a bottom and upright sides on a tray mounted on the vibrating conveyor will absorb the oscillations of the conveyor. A plurality of elongated channels extend longitudinally on the upper surface of the tray from the intake end to the exit end, whereupon the elongated line of crimped sausages deposited on the intake end of the tray in the form of sausage line segments or individual links will progressively move into the channels of the tray and will progressively move towards the exit end of the tray with the links and the line of sausage segments being aligned in parallel fashion.

### BACKGROUND OF THE INVENTION

A typical sausage co-extrusion process produces a continuous sausage rope that is typically crimped in a crimper wheel into individual sausages. The sausages are then conveyed to an oven belt, cooler/freezer belt, or other take away belt system. Transferring the sausages from the crimper wheel to a belt in an organized manner has been very difficult and is not done very effectively. For example, the speed at which the co-extruded sausage rope is fed into the crimper can be as high as 4.5 feet per second. In the production of a 1.75 inch long cocktail sausage, 31 individual sausages fall out of the crimper per second. These sausages need then be transferred and organized onto a flat belt so that they can be cooked, cooled, frozen, or packaged. Conventional methods of transferring these sausages damage the integrity of the sausages. Conventional collating systems such as Drake loaders or Planet loaders cannot organize fresh individual link sausages. The product handling is too rough and damage (deformation, breakage, tearing, jam ups, etc.) will occur.

When the sausages are randomly deposited onto a processing belt, touching will occur which results in touch marks. These are unsightly discoloration spots on the sausage surfaces. Also, the sausages tend to stick together which will result in tearing of the casing and packaging problems further down the line.

All conventional systems have the draw back in that they are very hard to clean and can be identified as bacteriological hazard areas. Often “first in, first out” of the individual sausages cannot be guaranteed. This could result in sausages staying in the loading system for an extended time and increase the danger of bacteriological growth and contamination.

All conventional systems also have the draw back that they cannot collate the sausages in such a way as to optimize the surface of the belt that needs to be loaded. It is very important to put as many sausage links onto the processing belt to maximimize thru put but avoiding touchers or other integrity damage.

It is therefore an object of this invention to achieve the following goals:

The sausages need to be loaded onto the belt in a single layer.

The space between the individual sausages must be minimized. This is to achieve the greatest belt load to maximize the utility of the oven or cooler/freezer.

All the sausages need to be oriented length wise or crosswise to maximize the belt load and match further processing machines downstream.

The sausages need to spread out to the full width of the belt. Any unfilled belt space hurt the efficiency of the production line. With new installations belt load is a determining factor of the size of an oven or freezer in turn directly related to the size of capital expenditure.

The apparatus needs to be easy to clean.

The apparatus needs to handle the sausage on a first in, first out basis so that no sausages stay in the loading system longer than necessary.

The apparatus needs to be able to completely load the belt at varying production speeds.

These and other objects will be apparent to those skilled in the art.

### SUMMARY OF THE INVENTION

The invention is a method to achieve the above mentioned product requirements by combining the unique characteristics of co-extruded sausages with vibratory conveying technology. The sausages fall out of the linker directly onto the vibratory conveyor, a swinging arm or chute provides the first spreading action. The vibrations of the conveyor conveys the sausages forward, moves them into a single layer and spreads them sideways. Elongated channels orient the sausages so they all start moving lengthwise down the conveyor. A series of narrow grooves having a width slightly wider than the diameter of the sausages capture the sausages and they move forward in a precise path. At the end of the vibratory conveyor the sausages are all side by side covering the width of the conveyor. A conveyor belt (to cook, chill, freeze or package) with equal width as the vibrating conveyor takes the sausages from the vibratory table. The belt is going a little faster than the speed of the sausages coming off the tray is to ensure that no end to end touching occurs.

This invention also comprises an apparatus that achieves the above mentioned product requirements.

### DESCRIPTION OF THE DRAWINGS

FIG. 1 is a schematic plan view of the system for conveying and collating crimped sausages of this invention;

FIG. 2 is an enlarged scale partial perspective view thereof;

FIG. 3 is a plan view of the conveyor tray;

FIG. 4 is a sectional view thereof taken on line 4-4 of FIG. 3;

FIG. 5 is a sectional view taken on line 5-5 of FIG. 3;

FIG. 6 is a partial enlarged scale plan view of the intake end of the tray of FIGS. 1 and 2;

FIG. 7 is an enlarged scale partial sectional view on line 7-7 of FIG. 1;

FIG. 8 is a sectional view similar to that of FIG. 7 but taken on line 8-8 of FIG. 1; and

FIG. 9 is an elevational view of a segment of a line of sausages.

### DESCRIPTION OF THE PREFERRED EMBODIMENT

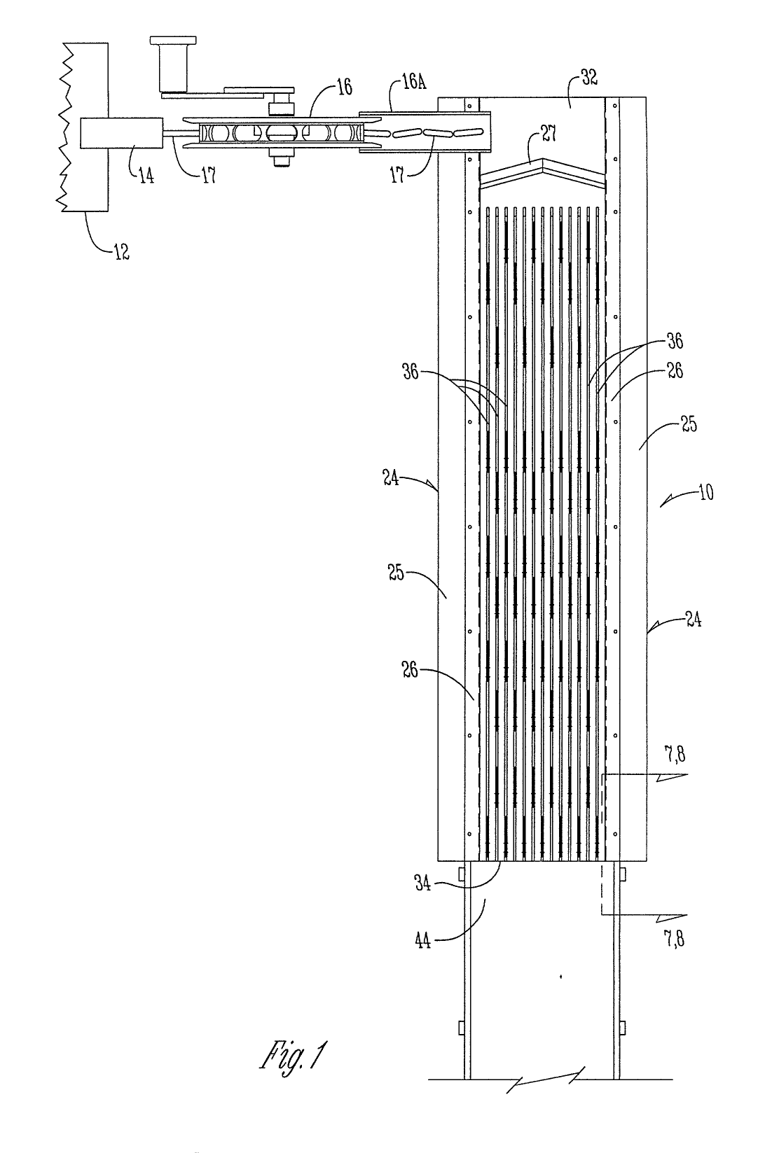

The numeral 10 generally designates the system of this invention. With reference to FIG. 1, a conventional co-extrusion sausage machine 12 has a discharge horn 14 which has a sausage crimping wheel 16 located downstream of horn 14. The crimping wheel 16 is of the type shown in co-pending U.S. application Ser. No. 09/524,229 filed Mar. 13, 2000, which is incorporated herein by reference. A conventional discharge chute from the crimping wheel 16 produces an elongated line of separated sausages 17 (FIG. 1). Chute 16A is adapted to carry the crimped line of sausages 17 away from crimping wheel 16. A segment of a line of sausages is shown in FIG. 9 and is designated by the numeral 18. It is comprised of three separated sausage links 20. While FIG. 9 shows only the sausage line segment of three links, it reveals the typical arrangement of the elongated sausage line 17 of FIG. 1.

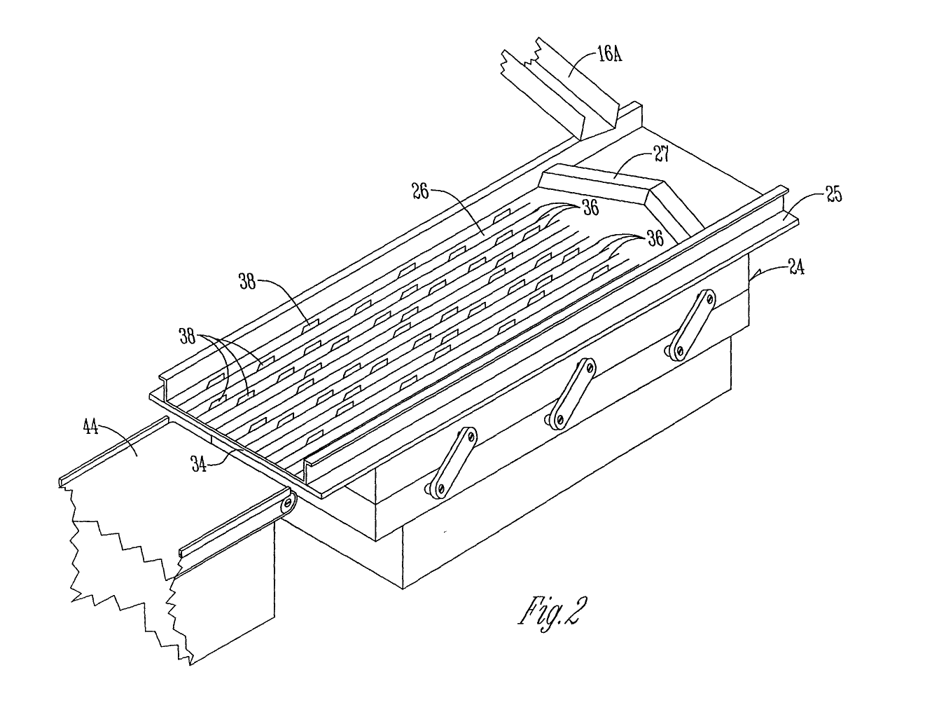

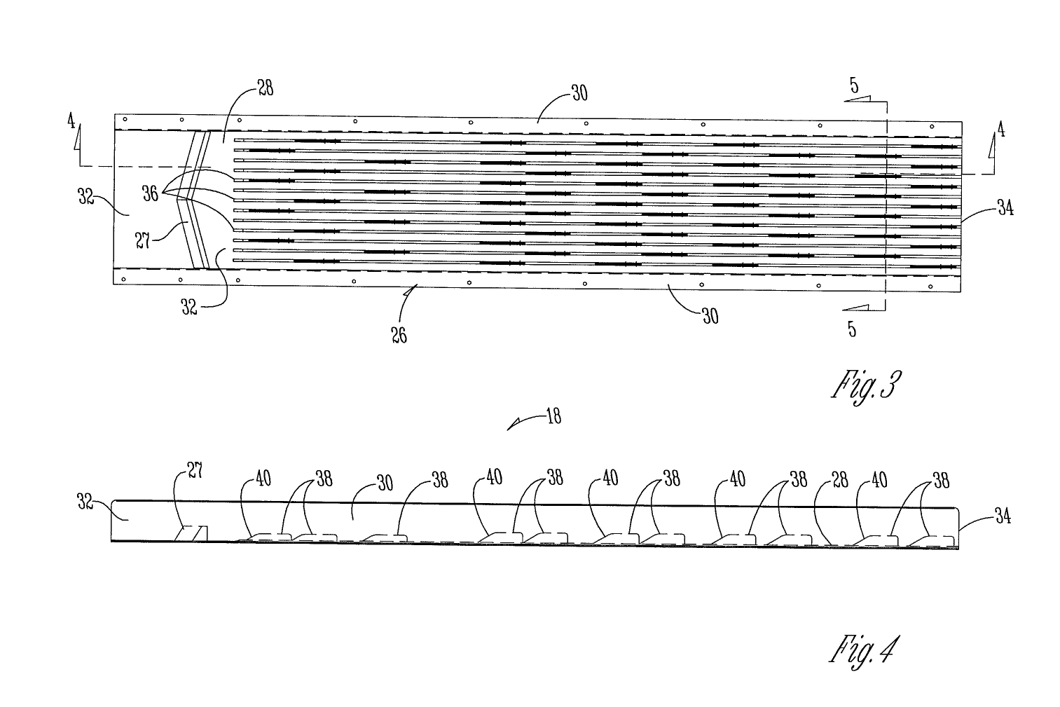

The vibratory conveyor 24 is shown in whole or apart in FIGS. 1, 2 and 6. The conveyor 24 having a conveyor deck 25 is of conventional construction and is shown, for example, in U.S. Pat. No. 6,019,216. See also U.S. Pat. No. 5,314,056. The conveyor 24 can shake and be tilted downwardly, or could move in a slight circular motion and be tilted upwardly. The term “vibrating” used herein embodies both systems.

An elongated substantially rectangular tray 26 has a bottom 28, sides 30, an intake end 32 and an exit end 34 (FIG. 3). Tray 26 is mounted on deck 25 of vibrating conveyor 24. It has a v-shaped bracket 27 on deck 25 just downstream from chute 16A. A plurality of elongated closely spaced grooves 36 are formed in the bottom 28 of tray 26 (FIG. 5) and receive a plurality of spacers 38 which are flat plates with a tapered end 40. The spacers 38 are spaced along the length of grooves 36. The spacers 38 are staggered with respect to the spacers in adjacent grooves as best shown in FIG. 3. Channels 42 are thereupon defined by adjacent rows of spacers 38. (FIG. 5)

A conventional flat belt conveyor 44 is located downstream of the exit end 34 of tray 26 to receive encased sausages as will be described hereafter. The vibratory conveyor 44 has a discharge edge 46.

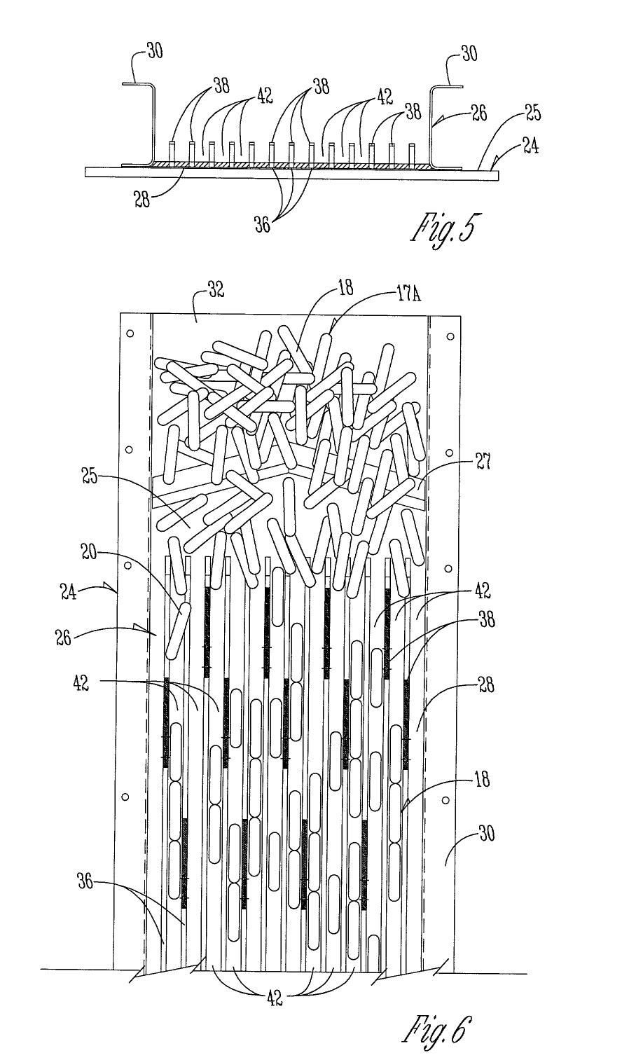

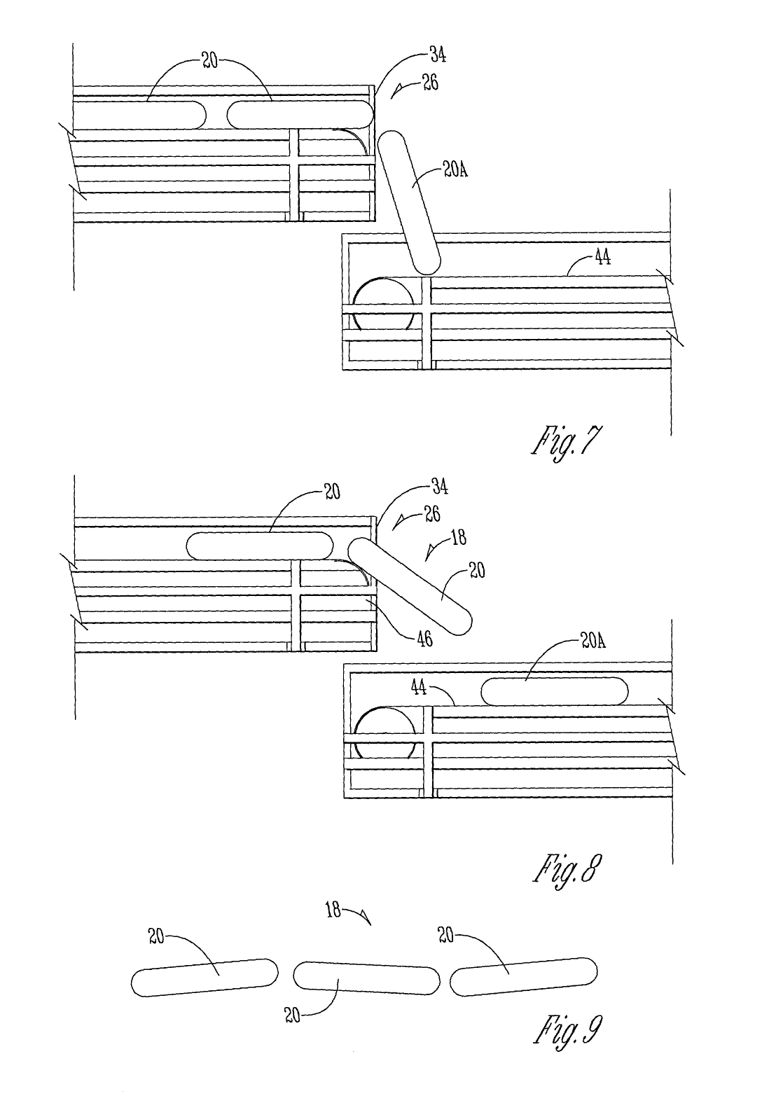

In operation, an elongated line of crimped sausages 17 is deposited on the intake end 32 of tray 26 above v-shaped bracket 27 as best shown in FIGS. 1 and 6. The velocity of the exiting line 17 from the chute 16A normally will cause the line 17 to separate into randomly positioned links 20. The speed and velocity of line 17 causes it to combine into a conglomerate mass 17A on the intake end 32 of tray 26 as best shown in FIG. 6. The vibratory conveyor 24 and deck 25 are actuated so as to impart oscillations or vibrations to the deck 25, and hence to the tray 26. These vibrations cause the mass of sausage lines on the intake end of tray 26 to move and migrate outwardly along the bottom 28 of the tray to encounter the various spacers 38 and the channels 42. The sausages in mass 17A bounce against and over bracket 27 as it vibrates and causes the mass 17A to disintegrate into a fan shape as they slide downwardly and outwardly towards the sides of the tray 26. This facilitates the entry of the sausage lines into the channels 42. The center of bracket 27 is upstream from the outer diagonal ends thereof. The width of channels 42 is slightly greater than the diameter of the individual links 20. This vibratory action causes the links 20 to become aligned in parallel relation in the parallel channels 42. Continued vibrations cause the links 20 to migrate towards the exit end 34 of the tray.

The aligned links 20 move onto conveyor 44 in aligned condition and move downstream where they fall off of the discharge edge 34 of tray 26 onto processing belt conveyor 44. The linear speed of conveyor 44 is slightly greater than the discharge speed of links from tray 26 whereupon, when the link 20A moves to the surface of conveyor 44, it will be further separated from the adjacent upstream link 20.

This invention enables the sausages to be loaded onto the conveyor 44 in a single layer which avoids the touch marks that would be appearing on the sausages during cooking if they were piled in layers. The sausages do not have an opportunity to touch each other once they move from the mass of material 17A as shown in FIG. 6 and into the channels 42 of the tray 26.

The space between the individual sausages is minimized to achieve the greatest belt load and to maximize the utility of the oven or cooler/freezer. It is also seen that the device and system of this invention permit the conveyors to be easily cleaned.

Accordingly, this invention will achieve at least all of its stated objectives.

What is claimed is:

1. A system for conveying and collating a crimped sausage strand, comprising,
an elongated vibratory conveyor deck powered to oscillate on a supporting frame, the deck having a longitudinal axis,
a tray having a bottom and upright sides and intake and exit ends on the deck to absorb the oscillation of the deck,
a plurality of elongated channels extending longitudinally on an upper surface of the tray from the intake end to an exit end,
whereupon an elongated line of crimped sausages deposited on the intake end of the tray in the form of sausage segments and individual links will progressively move into the channels of the tray and will progressively move towards the exit end with a longitudinal axis of the strand segments and links being aligned in parallel fashion in response to the absorbed oscillations of the tray from the conveyor deck.

2. The system of claim 1 wherein the conveyor deck and tray are tilted from the intake end toward the exit end of the conveyor deck.

3. The system of claim 1 wherein the channels have a plurality of elongated spacer elements upstanding between the channels.

4. The system of claim 3 wherein the end of the spacers away from the exit end of the conveyor deck are angled downwardly towards the intake end of the conveyor deck.

5. The system of claim 3 wherein the spacers on one side of a channel are longitudinally staggered with respect to the spacer or the other side of the channel.

6. The system of claim 1 wherein a movable flat conveyor is located adjacent the exit end of the tray to receive longitudinally aligned sausage links.

7. The system of claim 1 wherein a sausage line crimping apparatus is located adjacent the inlet end of the tray to deliver an elongated line of co-extruded separated sausages to the intake end of the tray.

8. A method for producing, conveying and collating crimped sausages, comprising,
producing an elongated line of crimped sausages comprising a plurality of separate sausage links,
depositing the line of crimped sausage links onto an intake end of an elongated tray,
vibrating the tray to cause an accumulation of links to move into a plurality of elongated channels extending from the intake end of the tray to an exit end of the tray to longitudinally align themselves in the channels to cause their migration towards the exit end.

9. The method of claim 9 wherein a processing belt conveyor is closely located downstream and slightly below the discharge edge of the tray, with the speed of the conveyor being greater than that of the velocity of the links exiting the tray so to increase the distance between the links.

10. The system of claim 1 wherein a v-shaped guide with side portions extending downwardly and outwardly along the bottom of the tray is located upstream of the elongated channels to facilitate the movement of sausages into the channels, with the bracket having two sides that extend outwardly from a center point and downstream towards the exit end.
